(19) United States
(12) Patent Application Publication
(10) Pub. No.: US 2021/0031950 A1
(43) Pub. Date: Feb. 4, 2021

(54) METHOD FOR CONTROLLING SPATIAL RESOLUTION OF EARTH OBSERVATION SYSTEM

(71) Applicant: Beijing Space Quest Co., LTD., Beijing City (CN)

(72) Inventor: SUQUAN DING, Beijing City (CN)

(21) Appl. No.: 16/729,479

(22) Filed: Dec. 29, 2019

(30) Foreign Application Priority Data
Jul. 30, 2019 (CN) 201910692839.9

(51) Int. Cl. B64G 1/24; G05D 1/04; G01S 19/15; G01S 19/42

(52) U.S. Cl. CPC B64G 1/242; G01S 19/42; G01S 19/15; G05D 1/04

(57) ABSTRACT

Disclosed is a method for controlling spatial resolution of an earth observation system, where, control of the spatial resolution is implemented by changing the orbit height, not the one-time orbit changing but multiple fine orbit changing is adopted, since adjustment during orbit changing each time does not change greatly, it is only fine adjustment or linear adjustment, which has no significant effect on the system, and improves stability of the system; an orbit three-dimensional simulation system for earth observation flight is established in advance, during control of the spatial resolution, an orbit height adjustment control instruction is sent to the aircraft control system in the sky and the orbit three-dimensional simulation system on the ground simultaneously, each time the orbit height is changed, an adjustment simulation result is returned by the orbit three-dimensional simulation system on the ground, subsequent adjustment and operation are performed according to the adjustment simulation result.

### CROSS REFERENCE TO RELATED APPLICATION

This application claims priority to Chinese Patent Application No. 201910692839.9, filed on Jul. 30, 2019, the entire content of which is incorporated herein by reference for all purposes.

### TECHNICAL FIELD

The present disclosure relates to the technical field of earth observation, and more particularly, to a method for controlling spatial resolution of an earth observation system.

### BACKGROUND

As an emerging technology, an earth observation system is playing an increasingly important role. In the earth observation system, an aircraft is used as a remote sensing platform, electromagnetic wave spectral bands such as visible light, infrared light, and microwave light are used for detecting a ground object on the earth, electromagnetic waves reflected back are received, and the characteristic of the ground object is analyzed. Spatial resolution refers to the dimension or size of the smallest unit that can be distinguished in detail on the remote sensing images collected by the earth observation system, is an indicator used to characterize the details of the ground object by images, and is typically represented by pixel size, image resolution ratio or angle of view.

In the prior art, the spatial resolution of the earth observation system can be adjusted by adjusting an orbit height of an aircraft. In general, the lower the orbit is, the higher the spatial resolution is, and conversely, the lower the spatial resolution is, however, the control of the spatial resolution in the prior art generally adopts one-time orbit changing, although orbit changing can be achieved quickly by such a manner, if the height in the one-time orbit changing changes too much, the earth observation system will be caused unstable in a short time.

### SUMMARY

The technical problem to be solved in the present disclosure is to provide a method for controlling spatial resolution of an earth observation system, which can effectively improve the stability of the earth observation system when the spatial resolution is controlled.

To solve the above technical problem, the present disclosure adopts the technical solutions as follows:

Provided is a method for controlling spatial resolution of an earth observation system, including the following steps of:

establishing an orbit three-dimensional simulation system for earth observation flight;

determining a first orbit height adjustment amount according to current orbit height data of an aircraft and a target spatial resolution;

sending a first orbit height adjustment control instruction to an aircraft control system and the orbit three-dimensional simulation system simultaneously, wherein the first orbit height adjustment control instruction carries the first orbit height adjustment amount;

making orbit height adjustment, by the aircraft control system and the orbit three-dimensional simulation system, according to the first orbit height adjustment control instruction;

returning an orbit height adjustment simulation result, by the orbit three-dimensional simulation system, and determining a second orbit height adjustment amount according to the orbit height adjustment simulation result and the target spatial resolution;

continuing to send a second orbit height adjustment control instruction to the aircraft control system and the orbit three-dimensional simulation system simultaneously, wherein the second orbit height adjustment control instruction carries the second orbit height adjustment amount;

making orbit height adjustment, by the aircraft control system and the orbit three-dimensional simulation system, according to the second orbit height adjustment control instruction, wherein the orbit three-dimensional simulation system returns an orbit height adjustment simulation result, and determines a new orbit height adjustment amount according to the orbit height adjustment simulation result, the new orbit height adjustment control instruction continues to be sent to the aircraft control system and the orbit three-dimensional simulation system simultaneously to make repeated orbit height adjustment until the orbit height adjustment simulation result returned by the orbit three-dimensional simulation system reaches an orbit height required by the target spatial resolution and then no further orbit height adjustment is made.

As compared with prior art, the present disclosure has at least the following advantages:

In the method for controlling spatial resolution of an earth observation system according to the present disclosure, the control of the spatial resolution is implemented by changing the orbit height, not the one-time orbit changing but multiple fine orbit changing is adopted, since adjustment during orbit changing each time does not change greatly, it is only fine adjustment or linear adjustment, which has no significant effect on the system, improves stability of the system and reduces risk during orbit changing.

Additionally, if a ground-control center always performs orbit adjustment according to a feedback result of an aircraft control system in the sky, and the ground-control center needs to wait for the feedback result of the aircraft control system in the sky each time the orbit adjustment is made, then the operating stability and the operating convenience of the earth observation system are also influenced. However, in the method for controlling spatial resolution according to the present disclosure, an orbit three-dimensional simulation system for earth observation flight is established in advance; during control of the spatial resolution, an orbit height adjustment control instruction is sent to the aircraft control system in the sky and the orbit three-dimensional simulation system on the ground simultaneously, each time the orbit height is changed, an adjustment simulation result is returned by the orbit three-dimensional simulation system on the ground, subsequent adjustment and operation are performed according to the adjustment simulation result. Since the control of the spatial resolution can be performed without feeding back a real adjustment result by the aircraft control system in the sky, operating stability of the earth observation system can be effectively improved, and the operation is more convenient.

### BRIEF DESCRIPTION OF THE DRAWINGS

FIG. 1 is a schematic diagram illustrating the principle of controlling spatial resolution according to an orbit height in a method for controlling spatial resolution of an earth observation system according to the present disclosure;

FIG. 2 is a schematic diagram illustrating a system architecture of controlling spatial resolution by an earth observation system according to the present disclosure; and

FIG. 3 is a specific flowchart in a method for controlling spatial resolution of an earth observation system according to a first embodiment of the present disclosure.

### DETAILED DESCRIPTION

The principle of the earth observation system of the present disclosure is to control the spatial resolution according to changes in the orbit height. In particular, for different earth observation systems, an earth observation aircraft (such as, an earth observation small satellite) has different requirements for the spatial resolution to identify a ground object. Additionally, for different ground objects, such as sea and land, the requirements for the spatial resolution of the earth observation system are also different, in general, sea has lower spatial resolution requirements while land has higher spatial resolution requirements, and the specific spatial resolution requirements can be determined according to actual circumstances, which is not limited herein. It should be noted that, the spatial resolution of the earth observation system can be adjusted by controlling the orbit height in the case of fixed load parameters on the aircraft, as a specific embodiment of the present disclosure, an orbit of the aircraft is a solar synchronous orbit, and the spatial resolution is calculated by Formula (1) below:

$$R = \frac{1.22 h λ}{D} \qquad ( 1 )$$

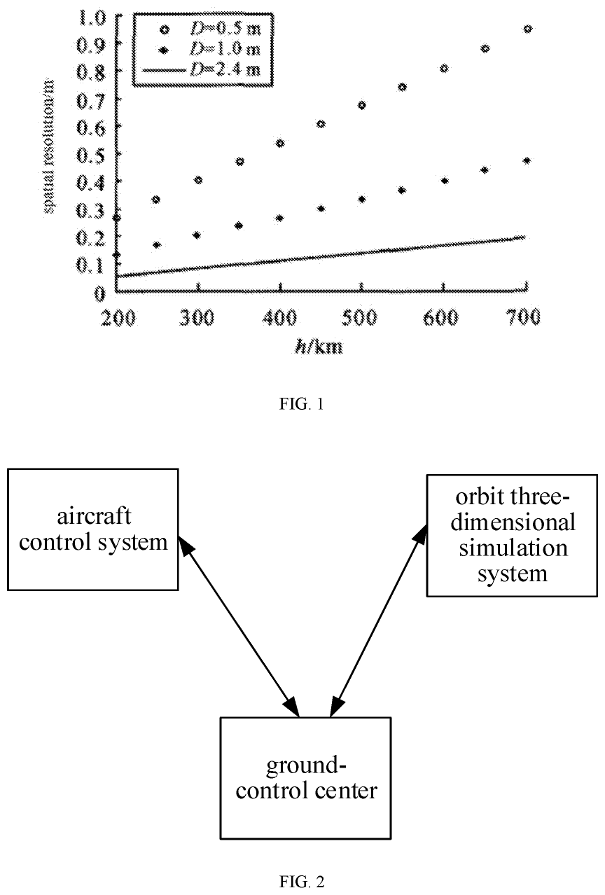

in the Formula (1): R is the spatial resolution, λ is the wavelength, D is the aperture diameter, h is the orbit height, and the relationship between the spatial resolution and the orbit height is illustrated in FIG. 1 when λ is taken as 0.55 μm, D is taken as 2.4 m, 1.0 m and 0.5 m, respectively. The control of the spatial resolution in the present disclosure can be implemented by adjusting the orbit height according to Formula (1), or can be calculated using other parameter values, which will not be described in detail herein.

Referring to FIG. 2, which is a schematic diagram illustrating a system architecture of controlling spatial resolution by an earth observation system according to the present disclosure, as illustrated in FIG. 2, the system architecture for controlling spatial resolution of the earth observation system according to the present disclosure mainly includes an aircraft control system and a ground-control center, and further includes an orbit three-dimensional simulation system, and in particular, the aircraft control system is a core part of the aircraft, and controls the aircraft during flight in a timely manner so as to ensure that the aircraft can fly along a predetermined orbit, and the ground-control center controls the aircraft on the ground, for example, when the aircraft cannot control itself or is inconvenient to control, all or part of the control rights over the aircraft are taken over by the ground-control center.

Additionally, the orbit three-dimensional simulation system according to the present disclosure is established in advance, and is to simulate an orbit state of an aircraft during flight in a real scenario, in the specific implementation, the orbit three-dimensional simulation system is modeled using a Rhino software, the orbit-related parameters involved in the orbit three-dimensional simulation system can be six orbital elements or other orbit-related parameters, which is not limited herein, and can be determined according to a specific real application scenario. Taking six orbital elements as an example in this embodiment, the running orbit of an aircraft, such as a small satellite, is determined by six parameters of an orbital semi-major axis α, an orbital inclination i, an argument of perigee ω, a right ascension of ascending node Ω, an eccentricity e, a true anomaly f, where, α and e determine the size and the shape of an orbit, i, Ω and ω determine the position of an orbit plane, f determines the position of an orbit where a small satellite is located, the orbit three-dimensional simulation system in this embodiment can be modeled according to the above parameters and other relevant parameters, using a Rhino software or other existing modeling software, in the specific implementation, various orbit states such as the orbit height can be simulated by adjusting different setup parameter values, and simulation results can be output, which will not be described in detail herein.

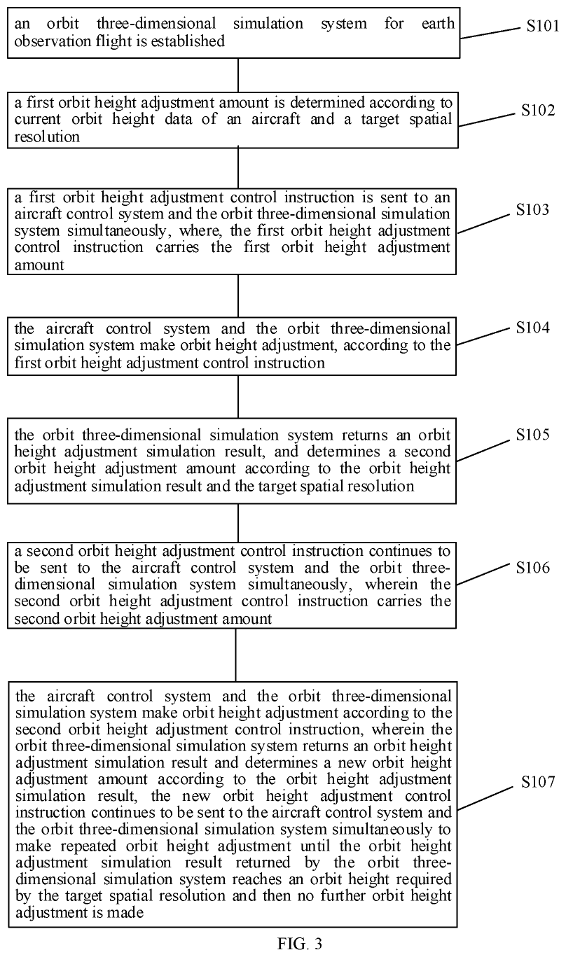

Referring to FIG. 3, which is a specific flowchart in a method for controlling spatial resolution of an earth observation system according to a first embodiment of the present disclosure, and the method in this embodiment mainly includes the following steps of:

Step S101, an orbit three-dimensional simulation system for earth observation flight is established, in the specific implementation, as described above, the orbit three-dimensional simulation system can be modeled using a Rhino software, obviously, other three-dimensional modeling software also can be used, which is not limited herein.

Step S102, a first orbit height adjustment amount is determined according to current orbit height data of an aircraft and a target spatial resolution, for example, the current orbit height is 642KM, the orbit height corresponding to the target spatial resolution is 574KM, and the first orbit height adjustment amount can be, for example, 13.6KM;

Step S103, a first orbit height adjustment control instruction is sent to an aircraft control system and the orbit three-dimensional simulation system simultaneously, where, the first orbit height adjustment control instruction carries the first orbit height adjustment amount;

Step S104, the aircraft control system and the orbit three-dimensional simulation system make orbit height adjustment, according to the first orbit height adjustment control instruction, in the specific implementation, the aircraft control system makes real adjustment according to the first orbit height adjustment amount, meanwhile, the orbit three-dimensional simulation system also performs simulation according to the first orbit height adjustment amount;

Step S105, the orbit three-dimensional simulation system returns an orbit height adjustment simulation result, and determines a second orbit height adjustment amount according to the orbit height adjustment simulation result and the target spatial resolution; in the specific implementation, the orbit height adjustment simulation result may conform to the first orbit height adjustment amount, i.e. the simulation result shows that the orbit height adjustment amount is the first orbit height adjustment amount (i.e. 13.6KM), and the adjustment conforms to the expectation, however, there may be the cases that the orbit adjustment amount does not conform to the expectation due to setup parameter value errors, or human errors or other reasons, i.e. the simulation result shows that the adjustment does not conform to the expectation, the orbit three-dimensional simulation system transmits predicted actual orbit adjustment amount (e.g. the actual orbit adjustment amount is 12.8KM), and subsequently determines a new orbit adjustment amount (i.e. the second orbit adjustment amount) according to the predicted actual orbit adjustment amount;

Step S106, a second orbit height adjustment control instruction continues to be sent to the aircraft control system and the orbit three-dimensional simulation system simultaneously, wherein the second orbit height adjustment control instruction carries the second orbit height adjustment amount;

wherein the orbit three-dimensional simulation system returns an orbit height adjustment simulation result, and determines a new orbit height adjustment amount according to the orbit height adjustment simulation result, the new orbit height adjustment control instruction continues to be sent to the aircraft control system and the orbit three-dimensional simulation system simultaneously to make repeated orbit height adjustment until the orbit height adjustment simulation result returned by the orbit three-dimensional simulation system reaches an orbit height required by the target spatial resolution and then no further orbit height adjustment is made.

Step S107, the aircraft control system and the orbit three-dimensional simulation system make orbit height adjustment according to the second orbit height adjustment control instruction, wherein the orbit three-dimensional simulation system returns an orbit height adjustment simulation result and determines a new orbit height adjustment amount according to the orbit height adjustment simulation result, the new orbit height adjustment control instruction continues to be sent to the aircraft control system and the orbit three-dimensional simulation system simultaneously to make repeated orbit height adjustment until the orbit height adjustment simulation result returned by the orbit three-dimensional simulation system reaches an orbit height required by the target spatial resolution and then no further orbit height adjustment is made.

It should be noted that, there is no need to wait for the feedback result of the aircraft control system for the next orbit height adjustment in this embodiment. Obviously, if it is necessary to wait for the feedback result of the aircraft control system, due to large time delay caused by the long distance between the air and the ground, or problems such as data transmission errors during communication, the operating stability of the ground-control center is weak, besides, if adjustment is made after the feedback result of the aircraft control system is received, a period of time has elapsed, and the aircraft may already be in another state, obviously, both the operating timeliness and the operating stability are not enough, but the simulation result returned by the orbit three-dimensional system in the present disclosure is immediate and the operating stability is stronger.

It should be noted that, in the specific implementation, as a preferred embodiment, the first orbit height adjustment amount, the second orbit height adjustment amount, and a subsequent orbit height adjustment amount may be distributed in equivalent sequences, such that each orbit adjustment amount is substantially uniform from the whole period of the adjustment, thus the effect of the orbit adjustment on the system substantially varies linearly and uniformly, i.e., the orbit adjustment has less effect on the system stability, adjustment amounts are performed multiple times, in terms of the whole process whether in one-time adjustment or multiple adjustments, the orbit adjustment is stably and slightly changed, and has no large influence on the system, that is, the influence on the system stability can be effectively reduced. Additionally, as another preferred embodiment, for example, the first orbit height adjustment amount, the second orbit height adjustment amount, and a subsequent orbit height adjustment amount are distributed in decreasing sequences by a factor of ½, similarly, since the effect of the orbit adjustment on the system is substantially linear, adjustment amounts are performed multiple times, in terms of the whole process whether in one-time adjustment or multiple adjustments, the stability of the system is much better. The first orbit height adjustment amount, the second orbit height adjustment amount, and the subsequent orbit height adjustment amount described above also can be determined according to specific conditions, as long as the orbit height is slightly adjusted in a substantially linear manner and the influence on the stability of the system can be effectively reduced, which will not be described in detail herein.

Additionally, as another preferred embodiment, a second specific embodiment of the present disclosure further includes: the orbit height adjustment amount is corrected according to actual orbit height data fed back by the aircraft control system at an interval of predetermined adjustment times, errors accumulated in the simulation process in this embodiment can be corrected according to the orbit height adjustment amount in a real scenario, so as to guarantee accuracy of the orbit adjustment.

Additionally, in the orbit changing process such as orbit height adjustment according to the present disclosure, jitter may appear on photoelectric sensors or the like on the aircraft, which may cause spatial resolution attenuation, as yet another preferred embodiment, a third specific embodiment of the present disclosure further includes:

an active structure isolation device is arranged on a photoelectric sensor of the aircraft, wherein the orbit height adjustment control instruction further carries startup indication information of the active structure isolation device, and the aircraft control system starts the active structure isolation device according to the startup indication information each time the orbit height is adjusted to suppress spatial resolution attenuation when the aircraft changes orbits, in the specific implementation, the active structure isolation device can adopt, for example, an electromechanical actuator or other active structure isolation devices, which is not limited herein.

Those described above are just preferred embodiments of the present disclosure and are not intended to limit the present disclosure. Any modification, equivalent alternation, and improvement made within the spirit and principle of the present disclosure fall within the scope of the present disclosure.

What is claimed is:

1. A method for controlling spatial resolution of an earth observation system, comprising the following steps of:
establishing an orbit three-dimensional simulation system for earth observation flight;
determining a first orbit height adjustment amount according to current orbit height data of an aircraft and a target spatial resolution;
sending a first orbit height adjustment control instruction to an aircraft control system and the orbit three-dimensional simulation system simultaneously, wherein the first orbit height adjustment control instruction carries the first orbit height adjustment amount;
making orbit height adjustment, by the aircraft control system and the orbit three-dimensional simulation system, according to the first orbit height adjustment control instruction;
returning an orbit height adjustment simulation result, by the orbit three-dimensional simulation system, and determining a second orbit height adjustment amount according to the orbit height adjustment simulation result and the target spatial resolution;
continuing to send a second orbit height adjustment control instruction to the aircraft control system and the orbit three-dimensional simulation system simultaneously, wherein the second orbit height adjustment control instruction carries the second orbit height adjustment amount;
making orbit height adjustment, by the aircraft control system and the orbit three-dimensional simulation system, according to the second orbit height adjustment control instruction, wherein the orbit three-dimensional simulation system returns an orbit height adjustment simulation result, and determines a new orbit height adjustment amount according to the orbit height adjustment simulation result, the new orbit height adjustment control instruction continues to be sent to the aircraft control system and the orbit three-dimensional simulation system simultaneously to make repeated orbit height adjustment until the orbit height adjustment simulation result returned by the orbit three-dimensional simulation system reaches an orbit height required by the target spatial resolution and then no further orbit height adjustment is made.

2. The method according to claim 1, wherein the first orbit height adjustment amount, the second orbit height adjustment amount, and a subsequent orbit height adjustment amount are distributed in equivalent sequences.

3. The method according to claim 1, wherein the first orbit height adjustment amount, the second orbit height adjustment amount, and a subsequent orbit height adjustment amount are distributed in decreasing sequences by a factor of ½.

4. The method according to claim 1, further comprising the following steps of:
correcting the orbit height adjustment amount according to actual orbit height data fed back by the aircraft control system at an interval of predetermined adjustment times.

5. The method according to claim 1, further comprising the following steps of:
arranging an active structure isolation device on a photoelectric sensor of the aircraft, wherein the orbit height adjustment control instruction further carries startup indication information of the active structure isolation device, and the aircraft control system starts the active structure isolation device according to the startup indication information each time the orbit height is adjusted to suppress spatial resolution attenuation when the aircraft changes orbits.

6. The method according to claim 1, wherein an orbit of the aircraft is a solar synchronous orbit.

7. The method according to claim 1, wherein the establishing the orbit three-dimensional simulation system for earth observation flight is modeled using a Rhino software.
